(19) United States
(12) Patent Application Publication
(10) Pub. No.: US 2024/0309250 A1
(43) Pub. Date: Sep. 19, 2024

(54) Two-Component Polyurethane Dispersion Adhesives

(71) Applicant: Coverstro Deutschland AG, Leverkusen (DE)

(72) Inventors: Joerg Buechner, Bergisch Gladbach (DE); Hans-Josef Laas, Odenthal (DE); Christoph Thiebes, Köln (DE); Thomas Fait, Köln (DE)

(21) Appl. No.: 18/576,967

(22) PCT Filed: Jul. 6, 2022
(86) PCT No.: PCT/EP2022/068750

§ 371 Date: Jan. 5, 2024

(30) Foreign Application Priority Data
Jul. 7, 2021 (EP) 21184250.5

(51) Int. Cl. C09J 175/06; C08G 18/12; C08G 18/80; C09J 5/00; C09J 175/08

(52) U.S. Cl. CPC C09J 175/06; C08G 18/12; C08G 18/8064; C08G 18/809; C09J 5/00; C09J 175/08; C09J 2400/166; C09J 2475/00

(57) ABSTRACT

The invention relates to two-component polyurethane dispersion adhesives including (I) at least one aqueous dispersion including an amorphous polyurethane-polyurea polymer and (II) at least one hydrophilically modified polyisocyanate, containing silane and thioallophanate structures, as a crosslinker component. The invention also relates to the use of these two-component polyurethane dispersion adhesives for producing multi-layered composites, especially those consisting of a synthetic substrate and a substrate with a metallic surface, and to the composite materials obtainable using the adhesives.

### CROSS-REFERENCE TO RELATED APPLICATIONS

This application is the United States national phase of International Application No. PCT/EP2022/068750 filed Jul. 6, 2022, and claims priority to European Patent Application No. 21184250.5 filed Jul. 7, 2021, the disclosures of which are hereby incorporated by reference in their entireties.

### BACKGROUND

### Technical Field

The invention relates to two-component polyurethane dispersion adhesives, comprising aqueous amorphous polyurethane-polyurea dispersions and hydrophilically modified polyisocyanates having silane and thioallophanate structures as crosslinkers, to the use of the polyurethane dispersion adhesives for the production of multilayer composites, particularly those consisting of a synthetic substrate and a substrate with a metallic surface, and to the multilayer composites adhesively bonded with these polyurethane dispersion adhesives.

### Description of Related Art

Polyurethane dispersion adhesives for the production of multilayer composites are known.

DE 102005006235 discloses aqueous polyurethane dispersions in which the polyurethane polymer comprises less than 0.6% of urea. The dispersions are processed as one component. The polyurethane dispersions are used for the production of multilayer composites that can be separated into the individual film layers again by boiling.

More resistant adhesive polymers are required for multilayer composites that are exposed to high temperatures during their use phase, for example boiling water. This is generally achieved by the additional use of crosslinkers. The crosslinker is added as a second component immediately before the polymer dispersion is processed. After the water has evaporated off, the molecules of the crosslinker react with the crosslinker-reactive groups in the polymer chain to form covalent bonds. A three-dimensional network is formed. The crosslinked polymer has a higher heat resistance than the uncrosslinked polymer.

Two-component processing is necessary particularly in the case of multilayer composites that are exposed to a high temperature during or after the packaging of food. Examples of such applications are for example packaged food that is sterilized after packaging in an autoclave with steam at 121° C. or 134° C. (see Commission Regulation (EU) No 10/2011 of Jan. 14, 2011 on plastic materials and articles intended to come into contact with food). The film layers of the multilayer composites must not separate during the sterilization. Another demanding application concerns the filling of hot food into multilayer composites (what is known as hot-filling). This involves filling food that is up to 95° C. into the multilayer composites. The film layers must retain their high bond strength under these conditions too.

U.S. Pat. No. 5,532,058 A describes improved multilayer composites (flexible laminates) consisting of thermoplastic films and/or metal foils that are exposed to boiling water. The multilayer composites are produced using polyurethane dispersions to which a crosslinker is added immediately before the processing to form the multilayer composite. Crosslinkers according to this invention are aziridines, carbodiimides or epoxies, and mixtures of these crosslinkers.

EP 278 844 7 B1 claims the use of aqueous polyurethane dispersions for composite film lamination, where at least 10% by weight of the polyurethane is composed of at least one amorphous polyester polyol, where the polyurethane dispersion comprises at least one external crosslinker and the external crosslinker is a polyisocyanate having at least two isocyanate groups. The aqueous adhesive dispersions can also be used for multilayer composites with aluminum foil, which are used in what are known as “hot-filling” applications.

Hydrophilically modified polyisocyanates bearing silane groups in the molecule are likewise known.

EP 0 872 499 A1 describes aqueous two-component binder combinations based on hydroxy- and/or amino-functional water-dilutable resins, and, as crosslinkers, compounds having isocyanate and alkoxysilyl groups obtained by partial reaction of polyisocyanates with aminoalkylalkoxysilanes. These two-component systems are used as binders in paints, coatings and sealants. The emulsifiability of the crosslinker components having isocyanate and alkoxysilyl groups in the aqueous binder is achieved by mixing with a hydrophilically modified polyisocyanate.

EP 0 949 284 A1 discloses hydrophilically modified polyisocyanates having a defined content of isocyanate and alkoxysilane groups, prepared by reacting polyisocyanates with secondary aminoalkylalkoxysilanes and hydrophilic nonionic or ionic formation components which enable the polyisocyanates modified in this way to be stably dispersed in water. These hydrophilic alkoxysilane-modified polyisocyanates serve as crosslinker components for aqueous dispersions of isocyanate-reactive polymers for the production of coating compositions, adhesives or sealants.

EP 953 585 provides water-emulsifiable polyisocyanates prepared by reacting hydrophobic polyisocyanates, preferably polyisocyanurate polyisocyanates, with mercaptosilanes as coupling agents and nonionic emulsifiers that are reactive toward NCO groups, have an HLB value of ≤17 and contain an average of 15 to 35 ethylene oxide units per molecule, in particular alkylphenol-initiated polyether alcohols. These water-emulsifiable polyisocyanates, which may optionally additionally comprise 3-glycidoxypropyltrimethoxysilane, serve inter alia as crosslinkers for aqueous adhesives.

EP 1 544 226 A1 describes aqueous two-component adhesives consisting of reaction products of polyisocyanates with substoichiometric amounts of alkoxysilane-functional aspartic esters and polyalkylene oxide polyether alcohols, and as a second component consisting of a catalyst and/or an aqueous binder. The adhesives serve in particular for the adhesive bonding of canvas or plastics to substrates, such as wood, metals, preferably iron or aluminum, plastics, paper, canvas, ceramic, stone, glass or concrete.

The two-component adhesives of the prior art are of only very limited suitability, if at all, for the production of multilayer composites having very high heat resistance and bond strength, such as those required for example for the hot sterilization of packaged food or for the filling of hot food.

As has now surprisingly been found, the use of specific hydrophilically modified polyisocyanates having silane and thioallophanate structures in combination with aqueous amorphous polyurethane-polyurea dispersions makes it possible to formulate two-component polyurethane dispersion adhesives for multilayer composites with at least one metal foil whose composite adhesion is not only maintained under the conditions of steam sterilization but even improved significantly.

### SUMMARY

The present invention provides two-component polyurethane dispersion adhesives comprising
(I) at least one aqueous dispersion comprising an amorphous polyurethane-polyurea polymer and
(II) at least one hydrophilically modified polyisocyanate having silane and thioallophanate structures as a crosslinker component.

The invention also provides for the use of these two-component polyurethane dispersion adhesives for the production of multilayer composites, particularly those consisting of a synthetic substrate and a substrate with a metallic surface, and provides the composite materials obtainable using the adhesives.

Suitable aqueous dispersions (I) in the context of the present invention are dispersions of polyurethane-polyurea polymers in water. These polymers comprise, as formation components,
(A) at least one amorphous polyester polyol having a molecular weight of at least 500 g/mol,
(B) at least one di- and/or polyisocyanate component,
(C) at least one compound selected from the group consisting of mono- to trihydric alcohols which additionally comprise at least one ionic group or at least one group convertible into an ionic group, monoamino- and diaminocarboxylic acids,
(D) optionally at least one compound selected from the group consisting of neutralizing amines and ammonia,
(E) optionally at least one diamine as chain extender and
(F) optionally other isocyanate-reactive compounds.

### DESCRIPTION

Amorphous in the context of this invention are solids whose building blocks are not arranged in crystal lattices, i.e. are not crystalline. According to the invention, amorphous polyesters are in particular those polyesters which have a melting peak of <5 J/g in a DSC measurement in accordance with DIN 65467:1999-03 at a heating rate of 20 K/min in the temperature range of −30° C. to +100° C. According to the invention, the amorphous polyurethane-polyurea polymer after drying has a glass transition temperature Tg of −65° C. to 10° C. and a melting temperature of 40° C. to 80° C. In other words, the present invention likewise provides two-component polyurethane dispersion adhesives comprising (I) at least one aqueous dispersion comprising an amorphous polyurethane-polyurea polymer and (II) at least one hydrophilically modified polyisocyanate having silane and thioallophanate structures as a crosslinker component, where the amorphous polyurethane-polyurea polymer after drying has a glass transition temperature Tg of −65° C. to 10° C. and a melting temperature of 40° C. to 80° C.

Preferably, the polyurethane-polyurea polymer comprises amorphous polyester polyols (A) in an amount of more than 20% by weight, preferably more than 40% by weight, particularly preferably more than 60% by weight, based on the polyurethane-polyurea polymer. Preferably, the amorphous polyester polyol has an average molecular weight, which can be calculated from the OH number, of at least 500 g/mol. Particularly preferably, the average molecular weight is between 1000 and 4000 g/mol, particularly preferably between 1700 and 2500 g/mol.

The amorphous polyester polyols (A) are preferably amorphous polyester diols (A) which are prepared using at least one aromatic dicarboxylic acid, preferably isophthalic acid and/or terephthalic acid, particularly preferably isophthalic acid.

In a preferred embodiment, the preparation of the amorphous polyester diol (A) uses a mixture of carboxylic acids, consisting of at least one aliphatic dicarboxylic acid having 3 to 10, preferably 4 to 8, carbon atoms and at least one aromatic dicarboxylic acid. The mixing ratio of aliphatic to aromatic dicarboxylic acids here is preferably from 0.5:1 to 2:1. A preferred dicarboxylic acid mixture is a mixture of adipic acid and isophthalic acid, in particular in a ratio of 0.5:1 to 2:1.

Polyhydric alcohols used for the preparation of the polyester diols (A) are for example ethylene glycol, propane-1,2-diol, propane-1,3-diol, butane-1,3-diol, butene-1,4-diol, butyne-1,4-diol, pentane-1,5-diol, hexane-1,6-diol, neopentyl glycol, bis(hydroxymethyl)cyclohexanes such as 1,4-bis(hydroxymethyl)cyclohexane, 2-methylpropane-1,3-diol, methylpentanediols, also diethylene glycol, triethylene glycol, tetraethylene glycol, polyethylene glycol, dipropylene glycol, polypropylene glycol, dibutylene glycol and polybutylene glycols. Preference is given to alcohols of the general formula HO—(CH₂)ₓ—OH, in which x is a number from 1 to 20, preferably an even number from 2 to 20. Examples thereof are ethylene glycol, butane-1,4-diol, hexane-1,6-diol, octane-1,8-diol and dodecane-1,12-diol. Further preference is given to neopentyl glycol.

Particular preference is given to butane-1,4-diol, hexane-1,6-diol and neopentyl glycol.

Suitable diisocyanates (B) for the preparation of the polyurethane-polyurea dispersions (I) are those of the molecular weight range 140 to 400 having aliphatically, cycloaliphatically, araliphatically and/or aromatically bonded isocyanate groups, such as 1,4-diisocyanatobutane, 1,5-diisocyanatopentane diisocyanate, (pentamethylene PDI), 1,6-diisocyanatohexane (hexamethylene diisocyanate, HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 2,4′- and 4,4′-diisocyanatodicyclohexylmethane (H₁₂-MDI), 1-isocyanato-1-methyl-4(3)isocyanatomethylcyclohexane, bis(isocyanatomethyl)norbornane, 1,3- and 1,4-bis(isocyanatomethyl)benzene (xylylene diisocyanate, XDI), 1,3- and 1,4-bis(2-isocyanatoprop-2-yl)benzene (TMXDI), 2,4- and 2,6-diisocyanatotoluene (TDI), 2,4′- and 4,4′-diisocyanatodiphenylmethane (MDI), 1,5-diisocyanatonaphthalene or mixtures of at least two such diisocyanates. The preparation of such diisocyanates is known; they can be obtained in various ways, for example by phosgenation of the corresponding diamines in the liquid or gas phase or by a phosgene-free route, such as by thermal urethane cleavage. Preferred diisocyanates are PDI, HDI, IPDI, XDI and/or TMXDI. Particular preference is given to the use of IPDI.

In addition to these diisocyanates, the preparation of the polyurethane-polyurea dispersions (I) may optionally partially also additionally use higher-functional polyisocyanates as component (B). Such higher-functional polyisocyanates are for example the polyisocyanates having an isocyanurate, iminooxadiazinedione, allophanate, biuret, urethane, carbodiimide and/or oxadiazinetrione structure that are obtainable by modifying the diisocyanates mentioned using processes known per se.

If at all, preferably polyisocyanates having isocyanurate structures and/or biuret structures, particularly preferably those based on HDI, are additionally used to a minor degree as higher-functional polyisocyanates.

Suitable components (C) which additionally comprise at least one ionic group or at least one group convertible into an ionic group are for example mono- to trihydric alcohols, monoamino- and diaminocarboxylic acids.

In particular, the mono- to trihydric alcohols (C) comprise anionic groups such as sulfonate, carboxylate and phosphate groups. The term “ionic group” is also intended to encompass groups that can be converted into ionic groups. Accordingly, the carboxylic acid, sulfonic acid or phosphoric acid groups convertible into ionic groups by neutralization are also regarded as ionic groups.

Suitable components C) comprising sulfonate or carboxylate groups are for example diamino compounds or dihydroxy compounds additionally bearing sulfonate and/or carboxylate groups, for example the sodium, lithium, potassium or tert-ammonium salts of N-(2-aminoethyl)-2-aminoethanesulfonic acid, N-(3-aminopropyl)-2-aminoethanesulfonic acid, N-(3-aminopropyl)-3-aminopropanesulfonic acid, N-(2-aminoethyl)-3-aminopropanesulfonic acid and the analogous aminocarboxylic acids, dimethylolpropionic acid, dimethylolbutyric acid, or the reaction products in the sense of a Michael addition of 1 mol of diamine, such as ethane-1,2-diamine or isophoronediamine, with 2 mol of acrylic acid or maleic acid.

Preferred components (C) are salts of N-(2-aminoethyl)-2-aminoethanesulfonic acid and dimethylolpropionic acid.

The acids (C) are preferably used directly in the form of their sulfonate or carboxylate salt. However, it is also possible to add some or all of the neutralizing agents (D) necessary for salt formation only during or after preparation of the polyurethanes.

Neutralizing agents (D) that are particularly suitable for salt formation are tertiary amines, such as triethylamine, dimethylcyclohexylamine, ethyldiisopropylamine.

Suitable as neutralizing agents (D) are also ammonia, amino alcohols, such as diethanolamine, triethanolamine, dimethylethanolamine, methydiethanolamine and aminomethylpropanol, and any desired mixtures of at least two amines of the type mentioned.

When using ammonia as neutralizing agent (D), at least some of the ammonia first reacts with the NCO groups present in the prepolymer, with addition and chain termination, and the remainder serves as neutralizing amine. When using ammonia, the number of remaining NCO groups and thus the ratio between chain extension and chain termination can be varied by prior reaction of the prepolymer with a diamine as chain extender (E). This enables the molecular weight of the polymer to be adjusted. When using ammonia, it is sensible to first react the prepolymer with the chain extender (E) and only subsequently add ammonia as the neutralizing agent (D).

In addition to the aminic compounds mentioned, it is optionally also possible to use alkali metal or alkaline earth metal hydroxides, such as sodium, potassium, lithium and calcium hydroxide, as neutralizing agent (D) for components C) containing sulfonate or carboxylate groups.

Chain extenders (E) used in the preparation of the polyurethane-polyurea dispersions (I) are optionally any desired diamines, such as ethane-1,2-diamine (ethylenediamine), pentamethylene-1,5-diamine, hexamethylene-1,6-diamine, 1-amino-3,3,5-trimethyl-5-aminomethylcyclohexane (isophoronediamine), piperazine, 1,4-diaminocyclohexane and bis(4-aminocyclohexyl)methane, adipic dihydrazide, hydrazine or hydrazine hydrate, and any desired mixtures of at least two diamines, in particular those of the type mentioned.

Preferred chain extenders (E) are ethylenediamine and isophoronediamine. Ethylenediamine is very particularly preferred.

In a very particularly preferred embodiment of the present invention, the preparation of the polyurethane-polyurea dispersions (I) uses ethylenediamine as chain extender (E) and ammonia as neutralizing agent (D).

Useful as other isocyanate-reactive compounds (F) are in principle all compounds that differ from (A) to (E) and that are reactive toward isocyanate, such as diols with a molecular weight of 62 to 499 g/mol, crystalline polyester diols, polymer diols based on polyethers, polylactones or polycarbonates, monoalcohols or mono- and polyamines.

For the preparation of the aqueous dispersions (I) present in the polyurethane dispersion adhesives according to the invention, it is possible to use all methods known from the prior art, such as emulsifier-shear force, acetone, prepolymer mixing, melt emulsification, ketimine and solid-state spontaneous dispersion methods or derivatives thereof. A summary of these methods can be found in Methoden der organischen Chemie [Methods of Organic Chemistry] (Houben-Weyl, Erweiterungs-und Folgebände zur 4. Auflage [Expansion and Supplementary Volumes for the 4th Edition], volume E20, H. Bartl and J. Falbe, Stuttgart, New York, Thieme 1987, pp. 1671-1682). Preference is given to the melt emulsification, prepolymer mixing and acetone methods. Particular preference is given to the acetone method. The application and performance of the acetone method is known from the prior art and to those skilled in the art from EP 0 232 778 for example.

As a crosslinker component (II), the two-component polyurethane dispersion adhesives according to the invention comprise at least one hydrophilically modified polyisocyanate having silane and thioallophanate structures, which preferably consists of at least one polyisocyanate (G) having silane and thioallophanate structures and at least one ionic and/or nonionic emulsifier (N).

Thioallophanate polyisocyanates (G) containing silane groups are known and described for example in WO 2015/189164. Said polyisocyanates are in particular those of the general formula (III)

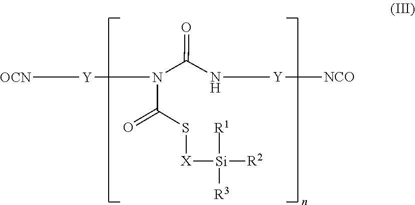

in which
R¹, R² and R³ are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen,
X is a linear or branched organic radical having at least 2 carbon atoms,
Y is a linear or branched, aliphatic or cycloaliphatic, an araliphatic or aromatic radical having up to 18 carbon atoms and
n is an integer from 1 to 20.

The preparation of such thioallophanates containing silane groups is likewise known and not a subject of this application. It is effected by reacting

(K) at least one monomeric diisocyanate of the general formula (IV)

OCN—Y—NCO (IV),

in which Y is a linear or branched, aliphatic or cycloaliphatic, an araliphatic or aromatic radical having up to 18 carbon atoms, with

(L) mercaptosilanes of the general formula (V)

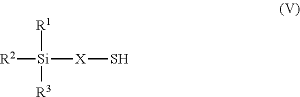

in which

R¹, R², R³ and X have the definition given above,

in an equivalents ratio of isocyanate groups to mercapto groups of 2:1 to 40:1.

Suitable starting compounds (K) for the process according to the invention are any desired diisocyanates having aliphatically, cycloaliphatically, araliphatically and/or aromatically bonded isocyanate groups, which may be prepared by any desired processes, for example by phosgenation or by a phosgene-free route, for example by means of urethane cleavage. Suitable diisocyanates are, for example, those of the general formula (IV)

OCN—Y—NCO (IV),

in which Y is a linear or branched, aliphatic or cycloaliphatic radical having up to 18 carbon atoms, preferably 4 to 18 carbon atoms, or an optionally substituted aromatic or araliphatic radical having up to 18 carbon atoms, preferably 6 to 18 carbon atoms, such as 1,4-diisocyanatobutane, 1,5-diisocyanatopentane, 1,6-diisocyanatohexane (HDI), 1,5-diisocyanato-2,2-dimethylpentane, 2,2,4- or 2,4,4-trimethyl-1,6-diisocyanatohexane, 1,8-diisocyanatooctane, 1,9-diisocyanatononane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H₁₂-MDI), 1,3- and 1,4-bis(isocyanatomethyl)cyclohexane, 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (xylylene diisocyanate, XDI), 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate and any desired mixtures of these isomers, diphenylmethane 2,4′- and/or 4,4′-diisocyanate and naphthylene 1,5-diisocyanate and any desired mixtures of such diisocyanates. Further diisocyanates which are likewise suitable are additionally found for example in Justus Liebigs Annalen der Chemie Volume 562 (1949) p. 75-136.

Particularly preferred as starting component (K) are diisocyanates of the general formula (IV) in which Y is a linear or branched, aliphatic or cycloaliphatic radical having 5 to 13 carbon atoms.

Very particularly preferred starting components (K) are 1,5-diisocyanatopentane, 1,6-diisocyanatohexane, 1-isocyanato-3,3,5-trimethyl-5-isocyanatomethylcyclohexane, 2,4′- and/or 4,4′-diisocyanatodicyclohexylmethane or any desired mixtures of these diisocyanates.

Starting components (L) for the preparation of the polyisocyanates (G) having silane and thioallophanate structures are any desired mercaptosilanes of the general formula (V)

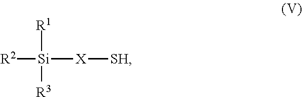

in which
R¹, R² and R³ are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen, and
X is a linear or branched organic radical having at least 2 carbon atoms.

Suitable mercaptosilanes (L) are for example 2-mercaptoethyltrimethylsilane, 2-mercaptoethylmethyldimethoxysilane, 2-mercaptoethyltrimethoxysilane, 2-mercaptoethyltriethoxysilane, 3-mercaptopropylmethyldimethoxysilane, 3-mercaptopropyldimethylmethoxysilane, 3-mercaptopropyltrimethoxysilane, 3-mercaptopropylmethyldiethoxysilane, 3-mercaptopropyltriethoxysilane, 3-mercaptopropylethyldimethoxysilane, 3-mercaptopropylethyldiethoxysilane and/or 4-mercaptobutyltrimethoxysilane.

Preferred mercaptosilanes (L) for the preparation of the polyisocyanates (G) having silane and thioallophanate structures are those of the general formula (V) in which
R¹, R² and R³ are identical or different radicals and are each a saturated, linear or branched, aliphatic or cycloaliphatic radical having up to 6 carbon atoms, which may optionally contain up to 3 oxygen atoms, and
X is a linear or branched alkylene radical having 2 to 10 carbon atoms.

Particularly preferred mercaptosilanes (L) are those of the general formula (V) in which
R¹, R² and R³ are each alkyl radicals having up to 6 carbon atoms and/or alkoxy radicals which contain up to 3 oxygen atoms, with the proviso that at least one of the radicals R¹, R² and R³ is such an alkoxy radical, and
X is a propylene radical (—CH₂—CH₂—CH₂—).

Very particularly preferred mercaptosilanes (L) are those of the general formula (V) in which
R¹, R² and R³ are identical or different radicals and are each methyl, methoxy or ethoxy, with the proviso that at least one of the radicals R¹, R² and R³ is a methoxy or ethoxy radical, and
X is a propylene radical (—CH₂—CH₂—CH₂—).

For the preparation of the polyisocyanates (G) having silane and thioallophanate structures, the diisocyanates (M) are reacted with the mercaptosilanes (L) at temperatures of 20° C. to 200° C., preferably 40° C. to 160° C., observing an equivalents ratio of isocyanate groups to mercapto groups of 2:1 to 40:1, preferably of 4:1 to 30:1, particularly preferably 6:1 to 20:1, to give thioallophanates.

This can be carried out uncatalyzed, as a thermally induced thioallophanatization. Preferably, however, suitable catalysts are used for accelerating the thioallophanatization reaction. These are the customary, known allophanatization catalysts, examples being metal carboxylates, metal chelates or tertiary amines of the type described in GB-A-0 994 890, alkylating agents of the type described in U.S. Pat. No. 3,769,318, or strong acids, as described for example in EP-A-0 000 194.

Suitable allophanatization catalysts are in particular zinc compounds, such as zinc(II) stearate, zinc(II) n-octanoate, zinc(II) 2-ethyl-1-hexanoate, zinc(II) naphthenate or zinc(II) acetylacetonate, tin compounds, such as tin(II) n-octanoate, tin(II) 2-ethyl-1-hexanoate, tin(II) laurate, dibutyltin oxide, dibutyltin dichloride, dibutyltin diacetate, dibutyltin dilaurate, dibutyltin dimaleate or dioctyltin diacetate, zirconium compounds, such as zirconium(IV) 2-ethyl-1-hexanoate, zirconium(IV) neodecanoate, zirconium(IV) naphthenate or zirconium(IV) acetylacetonate, aluminum tri(ethylacetoacetate), iron(III) chloride, potassium octoate, manganese compounds, cobalt compounds or nickel compounds, and strong acids, such as trifluoroacetic acid, sulfuric acid, hydrogen chloride, hydrogen bromide, phosphoric acid or perchloric acid, or any desired mixtures of these catalysts.

Also suitable, albeit less preferred, catalysts for the preparation of the polyisocyanates (G) having silane and thioallophanate structures are those compounds which in addition to the allophanatization reaction also catalyze the trimerization of isocyanate groups to form isocyanurate structures. Such catalysts are described for example in EP-A-0 649 866 page 4, line 7 to page 5, line 15.

Preferred catalysts for the preparation of the polyisocyanates (G) having silane and thioallophanate structures are zinc compounds and/or zirconium compounds of the abovementioned type. Very particularly preferred is the use of zinc(II) n-octanoate, zinc(II) 2-ethyl-1-hexanoate and/or zinc(II) stearate, zirconium(IV) n-octanoate, zirconium(IV) 2-ethyl-1-hexanoate and/or zirconium(IV) neodecanoate.

These catalysts are used, if at all, in an amount of 0.001% to 5% by weight, preferably 0.005% to 1% by weight, based on the total weight of the coreactants (M) and (L), and may be added either before the beginning of the reaction or at any time during the reaction.

The thioallophanatization is preferably carried out without a solvent. If desired, however, suitable solvents that are inert toward the reactive groups of the starting components can also additionally be used. Suitable solvents are for example the customary paint solvents which are known per se, such as ethyl acetate, butyl acetate, ethylene glycol monomethyl or monoethyl ether acetate, 1-methoxy-2-propyl acetate, 3-methoxy-n-butyl acetate, acetone, 2-butanone, 4-methyl-2-pentanone, cyclohexanone, toluene, xylene, chlorobenzene, white spirit, relatively highly substituted aromatics, such as those commercialized for example under the names solvent naphtha, Solvesso®, Isopar®, Nappar® (Deutsche EXXON CHEMICAL GmbH, Cologne, DE) and Shellsol® (Deutsche Shell Chemie GmbH, Eschborn, DE), but also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

In one possible embodiment, the polyisocyanates (G) having silane and thioallophanate structures may be prepared in such a way that the starting diisocyanate (M) or a mixture of various starting diisocyanates is initially charged optionally under inert gas, such as nitrogen, and optionally in the presence of a suitable solvent of the type mentioned at a temperature between 20° C. and 100° C. Subsequently, the mercaptosilane (L) or a mixture of various mercaptosilanes is added in the amount stated above and the reaction temperature for the thiourethanization is adjusted optionally by an appropriate measure (heating or cooling) to a temperature of 30° C. to 120° C., preferably of 50° C. to 100° C. Following the thiourethanization reaction, i.e. when the NCO content reached is that corresponding theoretically to complete conversion of isocyanate groups and mercapto groups, the thioallophanatization may be started for example without addition of a catalyst by heating of the reaction mixture to a temperature of 120° C. to 200° C. However, for acceleration of the thioallophanatization reaction, preference is given to using suitable catalysts of the abovementioned type, where, depending on the type and amount of the catalyst used, temperatures in the range of 60° C. to 140° C., preferably 70° C. to 120° C., are sufficient to carry out the reaction.

In another possible embodiment of the preparation of the polyisocyanates (G) having silane and thioallophanate structures, the catalyst for optional additional use is admixed either to the diisocyanate component (M) and/or to the silane component (L) even before the start of the actual reaction. In this case, the thiourethane groups formed as intermediates undergo spontaneous further reaction to give the desired thioallophanate structure. In this kind of one-stage reaction regime, the starting diisocyanates (M), optionally containing the catalyst, are initially charged, optionally under inert gas, such as nitrogen, and optionally in the presence of a suitable solvent of the type mentioned, in general at temperatures optimal for the thioallophanatization in the range from 60° C. to 140° C., preferably 70° C. to 120° C., and are reacted with the silane component (L) optionally containing the catalyst.

However, it is also possible to add the catalyst to the reaction mixture at any desired time during the thiourethanization reaction. In the case of this embodiment of the preparation of the polyisocyanates (G) having silane and thioallophanate structures, the temperature set for the pure thiourethanization reaction, which proceeds before the addition of catalyst, is generally in the range of 30° C. to 120° C., preferably of 50° C. to 100° C. Following addition of a suitable catalyst, the thioallophanatization reaction is finally carried out at temperatures of 60° C. to 140° C., preferably of 70° C. to 120° C.

In the preparation of the polyisocyanates (G) having silane and thioallophanate structures, the progress of the reaction can be monitored by determining the NCO content by titrimetric means for example. When the target NCO content has been reached, preferably when the degree of thioallophanatization (i.e. the percentage fraction, computable from the NCO content, of the thiourethane groups which have formed as intermediates from the mercapto groups of component (L) and have undergone reaction to form thioallophanate groups) of the reaction mixture is at least 70%, particularly preferably at least 90%, very particularly preferably after complete thioallophanatization, the reaction is discontinued. In the case of a purely thermal reaction regime, this may be effected for example by cooling the reaction mixture to room temperature. However, in the case of the preferred additional use of a thioallophanatization catalyst of the type mentioned, the reaction is generally stopped by addition of suitable catalyst poisons, for example acid chlorides such as benzoyl chloride or isophthaloyl dichloride.

The reaction mixture is preferably then freed from volatile constituents (excess monomeric diisocyanates, any solvents used in addition and, when no catalyst poison is used, any active catalyst) by thin-film distillation under a high vacuum, for example at a pressure of below 1.0 mbar, preferably below 0.5 mbar, particularly preferably below 0.2 mbar, under very gentle conditions, for example at a temperature of 100° C. to 200° C., preferably of 120° C. to 180° C.

The distillates obtained, which in addition to the unconverted monomeric starting diisocyanates contain any solvents used in addition and, when no catalyst poison is used, any active catalyst, can be used readily for renewed oligomerization.

In a further embodiment of the preparation of the polyisocyanates (G) having silane and thioallophanate structures, the volatile constituents mentioned are removed from the oligomerization product by extraction with suitable solvents that are inert toward isocyanate groups, for example aliphatic or cycloaliphatic hydrocarbons such as pentane, hexane, heptane, cyclopentane or cyclohexane.

Irrespective of the type of workup, the resulting products are clear, virtually colorless polyisocyanates (G) having silane and thioallophanate structures, generally with color numbers of below 120 APHA, preferably of below 80 APHA, particularly preferably of below 60 APHA, and an NCO content of 2.0% to 18.0% by weight, preferably 7.0% to 17.0% by weight, particularly preferably 10.0% to 16.0% by weight. The average NCO functionality, depending on the degree of conversion and the thioallophanatization catalyst used, is generally from 1.8 to 3.0, preferably from 1.8 to 2.5, particularly preferably from 1.9 to 2.0.

In addition to the polyisocyanate component (G), the hydrophilically modified polyisocyanates (II) having silane and thioallophanate structures comprise at least one ionic and/or nonionic emulsifier (N)

These are any desired surface-active substances which, due to their molecular structure, are capable of stabilizing polyisocyanates or polyisocyanate compositions in aqueous emulsions over a relatively long period of time, preferably up to 8 hours.

The hydrophilically modified polyisocyanates (II) having silane and thioallophanate structures are prepared by mixing the polyisocyanates (G) having silane and thioallophanate structures with the emulsifier component (N) or by forming the emulsifier component (N) in the polyisocyanate component (G) by partial reaction of polyisocyanate molecules of the polyisocyanate component (G) with ionic and/or nonionic compounds bearing groups that are reactive toward isocyanate groups.

A preferred type of nonionic emulsifiers (N) is represented for example by reaction products (N1) of the polyisocyanates (G) having silane and thioallophanate structures with hydrophilic polyether alcohols.

Suitable hydrophilic polyether alcohols are mono- or polyhydric polyalkylene oxide polyether alcohols having a statistical average of 5 to 50 ethylene oxide units per molecule, such as those accessible in a manner known per se by alkoxylation of suitable starter molecules (see for example Ullmanns Encyclopädie der technischen Chemie [Ullmann's Encyclopedia of Industrial Chemistry], 4th edition, volume 19, Verlag Chemie, Weinheim pp. 31-38). Such starter molecules may for example be any desired mono- or polyhydric alcohols of the molecular weight range 32 to 300, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3-methyl-3-hydroxymethyloxetane, benzyl alcohol, phenol, the isomeric cresols, octylphenols, nonylphenols and naphthols, furfuryl alcohol, tetrahydrofurfuryl alcohol, ethane-1,2-diol, propane-1,2- and -1,3-diol, the isomeric butanediols, pentanediols, hexanediols, heptanediols and octanediols, cyclohexane-1,2- and -1,4-diol, cyclohexane-1,4-dimethanol, 4,4′-(1-methylethylidene)biscyclohexanol, propane-1,2,3-triol, 1,1,1-trimethylolethane, hexane-1,2,6-triol, 1,1,1-trimethylolpropane, 2,2-bis(hydroxymethyl)propane-1,3-diol or 1,3,5-tris(2-hydroxyethyl) isocyanurate.

Alkylene oxides suitable for the alkoxylation reaction are in particular ethylene oxide and propylene oxide, which may be used in the alkoxylation reaction in any desired order or else in a mixture. Suitable polyether alcohols are either pure polyethylene oxide polyether alcohols or mixed polyalkylene oxide polyethers, the alkylene oxide units of which consist to an extent of at least 70 mol %, preferably to an extent of at least 80 mol %, of ethylene oxide units.

Preferred polyalkylene oxide polyether alcohols are those which have been prepared using the abovementioned monoalcohols of the molecular weight range 32 to 150 as starter molecules. Particularly preferred polyether alcohols are pure polyethylene glycol monomethyl ether alcohols having a statistical average of 5 to 50, very particularly preferably 5 to 25, ethylene oxide units.

The preparation of such preferred nonionic emulsifiers (N1) is known in principle and described for example in EP-B 0 206 059 and EP-B 0 540 985.

Said preparation may be effected by reacting the polyisocyanates (G) having silane and thioallophanate structures with the polyether alcohols mentioned either in a separate reaction step with subsequent mixing of the resulting emulsifier (N1) with the polyisocyanate components (G) to be converted to a hydrophilic form or else in such a way that the polyisocyanate components (G) are mixed with an appropriate amount of the polyether alcohols, where a hydrophilic polyisocyanate mixture according to the invention is spontaneously formed which, in addition to unreacted polyisocyanate (G) having silane and thioallophanate structures, comprises the emulsifier (N) which forms in situ from the polyether alcohol and some of component (G).

This type of nonionic emulsifiers (N1) is generally prepared at temperatures of 40° C. to 180° C., preferably 50° C. to 150° C., observing an NCO/OH equivalents ratio of 2:1 to 400:1, preferably of 4:1 to 140:1.

In the first-mentioned variant of the separate preparation of the nonionic emulsifiers (N1), these are preferably prepared observing an NCO/OH equivalents ratio of 2:1 to 6:1. In the case of the in situ preparation of the emulsifiers (N1), it is of course possible to use a large excess of isocyanate groups within the broad range mentioned above.

The reaction of the polyisocyanates (G) having silane and thioallophanate structures with the hydrophilic polyether alcohols mentioned to give nonionic emulsifiers (N1) may also be carried out according to the process described in EP-B 0 959 087 in such a way that the urethane groups primarily formed by NCO/OH reaction are further converted, at least partially, preferably to an extent of at least 60 mol %, to allophanate groups, based on the sum of urethane and allophanate groups. In this case, coreactants are reacted in the abovementioned NCO/OH equivalents ratio at temperatures of 40° C. to 180° C., preferably 50° C. to 150° C., generally in the presence of the catalysts suitable for accelerating the allophanatization reaction, as indicated in the cited patent specifications, in particular zinc compounds, such as zinc(II) n-octanoate, zinc(II) 2-ethyl-1-hexanoate or zinc(II) stearate.

Another preferred type of suitable nonionic emulsifiers (N) is represented for example also by reaction products of monomeric diisocyanates or diisocyanate mixtures with the abovementioned mono- or polyhydric hydrophilic polyether alcohols in an OH/NCO equivalents ratio of 0.6:1 to 1.2:1. Particular preference is given to the reaction of monomeric diisocyanates or diisocyanate mixtures with pure polyethylene glycol monomethyl ether alcohols having a statistical average of 5 to 50, preferably 5 to 25, ethylene oxide units. The preparation of such emulsifiers (N2) is also known and described for example in EP-B 0 486 881.

Optionally, however, the emulsifiers (N2) may also be reacted with the polyisocyanates (G) having silane and thioallophanate structures with allophanatization in the presence of suitable catalysts after the components have been mixed in the ratios described above. This also produces hydrophilic polyisocyanate compositions which, in addition to unreacted polyisocyanate (G), comprise a further nonionic emulsifier type (N3) with an allophanate structure which forms in situ from the emulsifier (N2) and some of component (G). The in situ preparation of such emulsifiers (N3) is also already known and described for example in WO 2005/047357.

Instead of the nonionic emulsifiers described by way of example, the hydrophilically modified polyisocyanates (II) having silane and thioallophanate structures may also comprise emulsifiers with ionic, in particular anionic, groups.

These ionic emulsifier components (N) are in particular reaction products of at least one polyisocyanate molecule of the polyisocyanates (G) having silane and thioallophanate structures with an aminosulfonic acid.

Such ionic emulsifiers (N) are preferably sulfonate group-containing emulsifiers (N4), such as those obtainable for example by the process of WO 01/88006 by reacting the polyisocyanate components (G) with 2-(cyclohexylamino)ethanesulfonic acid and/or 3-(cyclohexylamino)propanesulfonic acid or else with 4-(cyclohexylamino)butanesulfonic acid. This reaction generally takes place at temperatures of 40° C. to 150° C., preferably 50° C. to 130° C., observing an equivalents ratio of NCO groups to amino groups of 2:1 to 400:1, preferably of 4:1 to 250:1, where tertiary amines are additionally used, preferably in an equimolar amount based on the amount of aminosulfonic acid, for neutralization of the sulfonic acid groups. Suitable neutralizing amines are for example tertiary monoamines, such as trimethylamine, triethylamine, tripropylamine, tributylamine, dimethylcyclohexylamine, diisopropylethylamine, N-methylmorpholine, N-ethylmorpholine, N-methylpiperidine or N-ethylpiperidine, tertiary diamines, such as 1,3-bis(dimethylamino)propane, 1,4-bis(dimethylamino)butane or N,N′-dimethylpiperazine, or, although less preferred, alkanolamines, such as dimethylethanolamine, methyldiethanolamine or triethanolamine.

As already described for the nonionic emulsifiers (N1), the polyisocyanates (G) having silane and thioallophanate structures may also be reacted with the aminosulfonic acids mentioned either in a separate reaction step with subsequent mixing of the resulting ionic emulsifiers (N4) with the polyisocyanate components (G) to be converted to a hydrophilic form or else in situ in these polyisocyanate components, where a hydrophilically modified polyisocyanate (II) having silane and thioallophanate structures is directly formed which, in addition to unreacted polyisocyanate (G), comprises the emulsifier (N4) which forms in situ from the aminosulfonic acids, the neutralizing amine and some of components (G).

Another preferred type of suitable emulsifiers (N) are those which simultaneously comprise ionic and nonionic structures in one molecule. These emulsifiers (N5) are for example alkylphenol polyglycol ether phosphates and phosphonates or fatty alcohol polyglycol ether phosphates and phosphonates neutralized with tertiary amines, such as the neutralizing amines mentioned above, such as those described for example in WO 97/31960 for the hydrophilization of polyisocyanates, or else alkylphenol polyglycol ether sulfates or fatty alcohol polyglycol ether sulfates neutralized with such tertiary amines.

In this case, the emulsifier component preferably comprises at least one alkali metal salt or ammonium salt of an alkylphenol polyglycol ether phosphate, alkylphenol polyglycol ether phosphonate, fatty alcohol polyglycol ether phosphate, fatty alcohol polyglycol ether phosphonate, alkylphenol polyglycol ether sulfate and/or fatty alcohol polyglycol ether sulfate.

The polyisocyanates (G) having silane and thioallophanate structures may optionally also be mixed with hydrophilically modified polyisocyanates based on other polyisocyanates that differ from (G), for example those based on oligomeric polyisocyanates of PDI, HDI, IPDI and/or H₁₂-MDI having a uretdione, isocyanurate, allophanate, biuret, iminooxadiazinedione and/or oxadiazinetrione structure or any desired mixtures of such oligomeric polyisocyanates, to give hydrophilically modified polyisocyanates (II) having silane and thioallophanate structures. In such mixtures, the hydrophilically modified oligomeric polyisocyanates, which can be obtained by one of the above processes and may comprise the abovementioned emulsifier types (N1) to (N5), assume the function of an emulsifier for the admixed proportion of non-hydrophilic polyisocyanates (G) having silane and thioallophanate structures.

Irrespective of the type of the emulsifier (N) and the preparation thereof, the amount thereof or the amount of the ionic and/or nonionic components added to the polyisocyanates (G) during an in situ preparation of the emulsifier is generally measured such that the hydrophilically modified polyisocyanates (II) having silane and thioallophanate structures ultimately obtained comprise an amount of emulsifier (N) which ensures the dispersibility of the polyisocyanate mixture.

The preparation of the polyisocyanates (G) having silane and thioallophanate structures and of the hydrophilically modified polyisocyanates (II) having silane and thioallophanate structures and consisting of at least one ionic and/or nonionic emulsifier (N) may be effected without a solvent or optionally in a suitable solvent that is inert toward isocyanate groups, for example those described above as being suitable for the thioallophanatization in the preparation of the polyisocyanate component (G). The two-component polyurethane dispersion adhesives according to the invention preferably comprise 70% to 99% by weight of the polyurethane-polyurea dispersion (I) and 1% to 30% by weight of the hydrophilically modified polyisocyanate (II) having silane and thioallophanate structures as a crosslinker component (II). Particularly preferred polyurethane dispersion adhesives comprise 80% to 97% by weight of the polyurethane-polyurea dispersion (I) and 3% to 20% by weight of the hydrophilically modified silane group-containing polyisocyanate (II). Very particularly preferred polyurethane dispersion adhesives comprise 85% to 95% by weight of the polyurethane-polyurea dispersion (I) and 5% to 15% by weight of the hydrophilically modified polyisocyanate (II) having silane and thioallophanate structures.

The dispersion adhesives may be prepared by simple mixing of components (I) and (II). Preferably, the polyurethane-polyurea dispersion (I) is initially charged and the hydrophilically modified polyisocyanate (II) having silane and thioallophanate structures is added with stirring.

In order to facilitate the mixing of components (I) and (II), the hydrophilically modified polyisocyanate (II) having silane and thioallophanate structures may optionally also be predispersed with water before the polyurethane-polyurea dispersion (I) is added.

The dispersion adhesives according to the invention may be used alone or with the binders, auxiliaries and admixtures known in coatings and adhesives technology, particularly emulsifiers and light stabilizers, such as UV absorbers and sterically hindered amines (HALS), antioxidants, fillers and further auxiliaries, for example anti-settling agents, defoaming and/or wetting agents, flow control agents, reactive diluents, plasticizers, catalysts, auxiliary solvents and/or thickeners and additives, such as pigments, dyes or matting agents. Tackifiers may optionally also be added.

These binders, auxiliaries and admixtures may be added to the dispersion adhesives according to the invention immediately before it is processed. However, it is also possible to add at least some of these substances before or during the dispersing of the binder.

The selection and the metered addition of these substances, which may be added to the individual components and/or to the whole mixture, are known in principle to those skilled in the art and may be tailored to the specific application without unduly high effort and be determined by simple preliminary tests.

The two-component polyurethane dispersion adhesives according to the invention, consisting of at least one aqueous polyurethane-polyurea dispersion (I) and at least one hydrophilically modified polyisocyanate (II) having silane and thioallophanate structures as a crosslinker component, are of excellent suitability for the adhesive bonding of different materials, such as wood, metal, plastic, paper, textile, ceramic, glass or stone.

The polyurethane dispersion adhesives according to the invention are particularly suitable for the adhesive bonding of different materials in the production of multilayer composites, particularly of multilayer composites having at least one metal foil, such as those used for example for the packaging of food. Said adhesives result in high heat resistance of the adhesive bond and high bond strengths which are not only maintained under the conditions of hot sterilization but even improved significantly.

### EXAMPLES

All percentages are based on weight, unless stated otherwise.

NCO contents were determined titrimetrically in accordance with DIN EN ISO 11909:2007-05.

All viscosity measurements were performed with a Physica MCR 51 rheometer from Anton Paar Germany GmbH (DE) in accordance with DIN EN ISO 3219:1994-10 at a shear rate of 250 s-1.

Residual monomer contents were measured in accordance with DIN EN ISO 10283:2007-11 by gas chromatography with an internal standard.

The contents (mol %) of the thiourethane, thioallophanate and isocyanurate present in the polyisocyanate (G) having silane and thioallophanate structures were calculated from the integrals of proton-decoupled ¹³C NMR spectra (recorded on a Bruker DPX-400 instrument) and are based in each case on the sum of thiourethane, thioallophanate and isocyanurate groups present. The individual structural elements have the following chemical shifts (in ppm) measured in CDCl₃: thiourethane: 166.8; thioallophanate: 172.3 and 152.8; isocyanurate: 148.4.

The nonvolatile fractions in the aqueous polyurethane dispersions were determined in accordance with DIN EN ISO 3251:2003-07, with the conditions in the investigation being defined by the following parameters: 0.5 g/120 min/125° C.

Bond strength was determined using a universal tester from FRANK-PTI GmbH (DE). For this purpose, the test specimens were clamped in the clamping jaws of the tensile testing machine in such a way that the canvas fabric was able to be pulled off from the aluminum plate at a 180° angle. The aluminum plate was clamped in the upper clamping jaw and the end of the protruding canvas fabric strip was clamped in the lower clamping jaw. The tensile test was carried out at a pull-off speed of 100 mm/min.

### Feedstocks:

### Polyisocyanates

### Polyisocyanate 1

Polyisocyanate (G) having silane and thioallophanate structures 756 g (4.5 mol) of hexamethylene diisocyanate (HDI) was initially charged under dry nitrogen with stirring at a temperature of 80° C. and admixed with 0.1 g of zinc(II) 2-ethyl-1-hexanoate as catalyst. Over a period of about 30 minutes, 294 g (1.5 mol) of mercaptopropyltrimethoxysilane was added dropwise, with the temperature of the mixture increasing to 85° C. owing to the exothermic reaction that set in. The reaction mixture was stirred further at 85° C. until, after about 2 h, the NCO content had dropped to 24.0%. The catalyst was deactivated by addition of 0.1 g of orthophosphoric acid and the unreacted monomeric HDI was removed in a thin-film evaporator at a temperature of 130° C. and a pressure of 0.1 mbar.

This gave 523 g of a virtually colorless, clear polyisocyanate having silane and thioallophanate structures, which had the following characteristics and composition:
NCO content: 11.8%
Monomeric HDI: 0.06%
Viscosity (23° C.): 450 mPas
Thiourethane: 0.0 mol %
Thioallophanate: 99.0 mol %
Isocyanurate groups: 1.0 mol %

### Polyisocyanate 2

Hydrophilic HDI polyisocyanate in accordance with EP-B 0 540 985, emulsifier type (N1) 870 g (4.50 eq) of an isocyanurate group-containing polyisocyanate based on HDI having an NCO content of 21.7%, a content of monomeric HDI of 0.1% and a viscosity of 3000 mPas (23° C.) was initially charged under dry nitrogen with stirring at 100° C., admixed over the course of 30 min with 130 g (0.37 eq) of a methanol-initiated, monofunctional polyethylene oxide polyether having an average molecular weight of 350 and stirred further at this temperature until, after about 2 h, the NCO content of the mixture had fallen to a value of 17.4%. After cooling to room temperature, there was a colorless, clear polyisocyanate mixture having the following characteristics:
NCO content: 17.4%
Monomeric HDI: 0.08%
Viscosity (23° C.): 2800 mPas

### Polyisocyanate 3

Hydrophilically modified polyisocyanate (II)-3 having silane and thioallophanate structures, emulsifier type (N1)

500 g (1.40 eq) of polyisocyanate 1 was mixed with 500 g (2.07 eq) of polyisocyanate 2 at 50° C. under dry nitrogen and the mixture was homogenized by stirring for 30 minutes. After cooling to room temperature, there was a colorless, clear polyisocyanate mixture having the following characteristics:
NCO content: 14.6%
Monomeric HDI: 0.08%
Viscosity (23° C.): 1560 mPas

### Polyisocyanate 4

Hydrophilically modified polyisocyanate (II)-1 having silane and thioallophanate structures, emulsifier type (N1)

900 g (2.53 eq) of polyisocyanate 1 was initially charged under dry nitrogen with stirring at 80° C., admixed over the course of 30 min with 100 g (0.20 eq) of a methanol-initiated, monofunctional polyethylene oxide polyether having an average molecular weight of 500 and stirred further at this temperature until, after about 4 h, the NCO content of the mixture had fallen to a value of 17.4%. After cooling to room temperature, there was a colorless, clear polyisocyanate mixture having the following characteristics:
NCO content: 9.8%
Monomeric HDI: 0.05%
Viscosity (23° C.): 500 mPas

### Polyisocyanate 5

Hydrophilically modified polyisocyanate (II)-2 having silane and thioallophanate structures, emulsifier type (N4)

980 g (2.53 eq) of polyisocyanate 1 was admixed with 20 g (0.09 eq) of 3-(cyclohexylamino)propanesulfonic acid, 11.5 g (0.09 eq) of dimethylcyclohexylamine and 0.2 g (200 ppm) of 2,6-di-tert-butyl-4-methylphenol (ionol) under dry nitrogen with stirring at 80° C. and stirred further at this temperature until, after about 3 h, the NCO content of the mixture had fallen to a value of 11.0%. After cooling to room temperature, there was a colorless, clear polyisocyanate mixture having the following characteristics:
NCO content: 11.0%
Monomeric HDI: 0.06%
Viscosity (23° C.): 640 mPas

### Polyisocyanate 6

Hydrophilically modified polyisocyanate having silane structures in accordance with EP 1 544 226, Example 2 (Comparative 1)

690.3 g (3.58 eq) of Desmodur® N 3400 (polyisocyanate based on HDI, NCO content: 21.8%, viscosity (23° C.): 170 mPas; manufacturer: Covestro Deutschland AG) was initially charged under dry nitrogen with stirring at 45° C., admixed over the course of 20 min with 122 g (0.22 eq) of a methanol-initiated, monofunctional polyethylene oxide polyether having an average molecular weight of 550 and stirred further at this temperature until, after about 6 h, the NCO content of the mixture had fallen to a value of 17.3%. Subsequently, 171 g (0.49 eq) of a silane-functional aspartate prepared in accordance with Example 1 of EP 1 544 226 (addition product of 3-aminopropyltrimethoxysilane with diethyl maleate) was added in such a way that the temperature of the reaction mixture did not exceed 50° C. despite the exothermicity that set in. After a reaction time of 2 h at 50° C. and cooling to room temperature, there was a colorless, clear polyisocyanate mixture having the following characteristics:
NCO content: 12.2%
Monomeric HDI: 0.11%
Viscosity (23° C.): 680 mPas

### Polyisocyanate 7

Hydrophilically modified polyisocyanate having silane structures in accordance with EP 953 585, Example G (Comparative 2)

855 g (4.68 eq) of an isocyanurate group-containing polyisocyanate based on HDI having an NCO content of 23.0% and a viscosity (23° C.) of 1200 mPas was initially charged under dry nitrogen with stirring at 70° C., admixed over the course of 20 min with 119 g (0.22 eq) of a methanol-initiated, monofunctional polyethylene oxide polyether having an average molecular weight of 550 and 26 g (0.13 eq) of mercaptopropyltrimethoxysilane and then stirred further for 3 h at 80° C. After cooling to room temperature and addition of 5 g of y-glycidyloxypropyltrimethoxysilane, there was a colorless, clear polyisocyanate mixture having the following characteristics:
NCO content: 17.2%
Monomeric HDI: 0.08%
Viscosity (23° C.): 770 mPas

### Polyurethane-Polyurea Dispersions

Dispercoll U 42: Aqueous dispersion of an amorphous anionically modified polyurethane based on polyester polyol; nonvolatile fraction 50%
   (Covestro Deutschland AG, Leverkusen; DE)
Dispercoll U XP 2643: Aqueous dispersion of an amorphous anionically modified polyurethane based on polyether; nonvolatile fraction 40%
   (Covestro Deutschland AG, Leverkusen; DE)
Dispercoll U 2682: Aqueous dispersion of a partially crystalline anionically modified polyurethane based on polyester polyol; nonvolatile fraction 50%
   (Covestro Deutschland AG, Leverkusen; DE)
Dispercoll U 2824: Aqueous dispersion of a partially crystalline anionically modified polyurethane based on polyester polyol; nonvolatile fraction 40%
   (Covestro Deutschland AG, Leverkusen; DE)

### Preparation of the Adhesive Dispersions

The polyurethane-polyurea dispersions were initially charged into a vessel. The crosslinking polyisocyanate, or polyisocyanate mixture, was then added to the polyurethane-polyurea dispersions with stirring. The polyisocyanate or polyisocyanate mixture may optionally be predispersed with water in an earlier step for example in a 1:1 ratio.

### Production of the Adhesive Bonds:

The adhesive dispersions were applied to aluminum plates (W×D×H=50 mm×120 mm×1.7 mm) and to canvas fabric strips (30 mm×240 mm) using a brush. The canvas fabric strips coated with adhesive dispersion were then placed in the dispersion layer on the aluminum plate in such a way that the canvas fabric strips protruded 120 mm over the aluminum plate. The adhesive dispersion layer was dried, with the water evaporating through the canvas fabric. The drying was effected at 23° C./50% rel. humidity.

After storage for one week under standard conditions, in each case half of the adhesive composites (per adhesive dispersion) were sterilized in a Varioklav VI 400 EC sterilizer (HP Labortechnik GmbH, Oberschleißheim, DE) at 121° C. for 30 minutes in accordance with the operating instructions. After removal from the sterilizer, the samples were dried at 23° C./50% rel. humidity for 24 hours.

The adhesive composites were then tested with regard to bond strength. The table below shows the compositions of the dispersion adhesives in parts by weight and the bond strengths of the adhesive composites before and after steam sterilization each as an average of five individual measurements.

TABLE 1

| | 1 | | | | 5 | 6 | | | 9 | 10 |
|---|---|---|---|---|---|---|---|---|---|---|
| | (comparative) | 2 | 3 | 4 | (comparative) | (comparative) | 7 | 8 | (comparative) | (comparative) |
| Dispercoll | 100 | 100 | 100 | 100 | | | | | | |
| U 42 | | | | | | | | | | |
| (amorphous) | | | | | | | | | | |
| Dispercoll | | | | | | | 100 | 100 | 100 | 100 |
| U XP 2643 | | | | | | | | | | |
| (amorphous) | | | | | | | | | | |
| Dispercoll | | | | | 100 | | | | | |
| U XP 2682 | | | | | | | | | | |
| (partially | | | | | | | | | | |
| crystalline) | | | | | | | | | | |
| Dispercoll | | | | | | 100 | | | | |
| U XP 2824 | | | | | | | | | | |
| (partially | | | | | | | | | | |
| crystalline) | | | | | | | | | | |
| Polyisocyanate 1 | | | | | | | | | | |
| Polyisocyanate 2 | 5 | | | | | | | | | |
| Polyisocyanate 3 | | 6 | | | 6 | 6 | 6 | | | |
| Polyisocyanate 4 | | | 6 | | | | | | | |
| Polyisocyanate 5 | | | | 6 | | | | 6 | | |
| Polyisocyanate 6 | | | | | | | | | 6 | |
| Polyisocyanate 7 | | | | | | | | | | 6 |
| Bond | 0.71 | 0.88 | 0.52 | 0.41 | 3.32 | 1.11 | 0.23 | 0.34 | 0.20 | 0.24 |
| strength before | | | | | | | | | | |
| sterilization | | | | | | | | | | |
| [N/mm] | | | | | | | | | | |
| Bond | 0.49 | 1.34 | 0.55 | 0.66 | 0.89 | 0.62 | 3.43 | 1.53 | 0.18 | 0.33 |
| strength after | | | | | | | | | | |
| sterilization | | | | | | | | | | |
| [N/mm] | | | | | | | | | | |
| Change in bond | −31 | 52 | 6 | 61 | −73 | −44 | 1391 | 350 | −10 | 38 |
| strength [%] | | | | | | | | | | |

The comparison of Examples 1 to 4 shows that the bond strengths of adhesive composites produced using dispersion adhesives 2 to 4 according to the invention, which comprise, as crosslinker components, hydrophilically modified polyisocyanates (II) having silane and thioallophanate structures, in some cases are significantly increased under sterilization conditions, while the strength of an adhesive composite based on the same adhesive dispersion that with the silane group-free hydrophilic HDI polyisocyanate in accordance with EP-B 0 540 985 decreases significantly under the same conditions.

Comparative Examples 5 and 6 show that using partially crystalline polyurethane dispersions does not result in any improvement in the bond strength as a result of sterilization.

The comparison of Examples 7 to 10 shows that using hydrophilically modified polyisocyanates (II) having silane and thioallophanate structures results in a significant increase in the bond strength (Examples 7 and 8 according to the invention) under sterilization conditions, while the use of the hydrophilically modified polyisocyanates having silane structures from the prior art in combination with the same amorphous polyurethane dispersion only results in a very small increase or in a decrease in strength (Comparative Examples 9 and 10).

1. A two-component polyurethane dispersion adhesives comprising
(I) at least one aqueous dispersion comprising an amorphous polyurethane-polyurea polymer and
(II) at least one hydrophilically modified polyisocyanate having silane and thioallophanate structures as a crosslinker component.

2. The two-component polyurethane dispersion adhesives as claimed in claim 1, wherein the polyurethane-polyurea polymer of the aqueous dispersion (I) comprises, as formation components,
(A) at least one amorphous polyester polyol having a number-average molecular weight of at least 500 g/mol,
(B) at least one di- and/or one polyisocyanate component,
(C) at least one compound selected from the group consisting of mono- to trihydric alcohols which additionally comprise at least one ionic group and/or at least one group convertible into an ionic group, monoaminocarboxylic acids, diaminocarboxylic acids and any desired mixtures of the aforementioned,
(D) optionally at least one compound selected from the group consisting of neutralizing amines, ammonia and any desired mixtures of the aforementioned,
(E) optionally at least one diamine and
(F) optionally other compounds that are reactive toward isocyanate groups.

3. The two-component polyurethane dispersion adhesives as claimed in claim 1, wherein the polyurethane-polyurea polymer of the aqueous dispersion (I) comprises, as formation component,
(A) at least one amorphous polyester polyol in an amount of more than 20% by weight, based on the polyurethane-polyurea polymer.

4. The two-component polyurethane dispersion adhesives as claimed in claim 1, wherein the crosslinker component (II) comprises at least one hydrophilically modified polyisocyanate having silane and thioallophanate structures, consisting of at least one polyisocyanate (G) having silane and thioallophanate structures and at least one ionic and/or nonionic emulsifier (N).

5. The two-component polyurethane dispersion adhesives as claimed in claim 4, wherein the polyisocyanate (G) having silane and thioallophanate structures has the general formula (III), 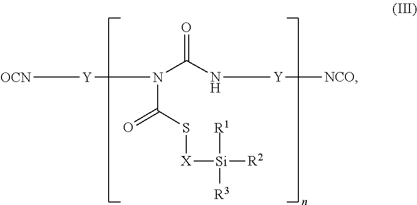
in which
R¹, R² and R³ are identical or different radicals and are each a saturated or unsaturated, linear or branched, aliphatic or cycloaliphatic or an optionally substituted aromatic or araliphatic radical having up to 18 carbon atoms, which may optionally contain up to 3 heteroatoms from the series of oxygen, sulfur and nitrogen,
X is a linear or branched organic radical having at least 2 carbon atoms,
Y is a linear or branched, aliphatic or cycloaliphatic, an araliphatic or aromatic radical having up to 18 carbon atoms and
n is an integer from 1 to 20.

6. The two-component polyurethane dispersion adhesives as claimed in claim 4, wherein the hydrophilically modified polyisocyanate having silane and thioallophanate structures of the crosslinker component (II) is prepared by mixing the polyisocyanates (G) having silane and thioallophanate structures with the emulsifier component (N) or by forming the emulsifier component (N) in the polyisocyanate component (G) by partial reaction of polyisocyanate molecules of the polyisocyanate component (G) with ionic and/or nonionic compounds bearing groups that are reactive toward isocyanate groups.

7. The two-component polyurethane dispersion adhesives as claimed in claim 4, wherein the emulsifier component (N) comprises at least one reaction product of at least one polyisocyanate (G) having silane and thioallophanate structures with a hydrophilic polyether alcohol.

8. The two-component polyurethane dispersion adhesives as claimed in claim 7, wherein the hydrophilic polyether alcohol is a polyethylene glycol monomethyl ether alcohol containing a statistical average of 5 to 50 ethylene oxide units.

9. The two-component polyurethane dispersion adhesives as claimed in claim 4, wherein the emulsifier component (N) comprises at least one reaction product of at least one polyisocyanate (G) having silane and thioallophanate structures with at least one aminosulfonic acid.

10. The two-component polyurethane dispersion adhesives as claimed in claim 9, wherein the aminosulfonic acid is 2-(cyclohexylamino)ethanesulfonic acid, 3-(cyclohexylamino)propanesulfonic acid and/or 4-(cyclohexylamino)butanesulfonic acid.

11. The two-component polyurethane dispersion adhesives as claimed in claim 4, wherein the emulsifier component (N) comprises at least one alkali metal salt or ammonium salt of an alkylphenol polyglycol ether phosphate, alkylphenol polyglycol ether phosphonate, fatty alcohol polyglycol ether phosphate, fatty alcohol polyglycol ether phosphonate, alkylphenol polyglycol ether sulfate and/or fatty alcohol polyglycol ether sulfate.

12. The two-component polyurethane dispersion adhesives as claimed in claim 4, wherein the hydrophilically modified polyisocyanates (II) having silane and thioallophanate structures are prepared by mixing polyisocyanates (G) having silane and thioallophanate structures with hydrophilically modified polyisocyanates based on other polyisocyanates that differ from (G).

13. The two-component polyurethane dispersion adhesives as claimed in claim 1, comprising 70% to 99% by weight of an aqueous dispersion of a polyurethane-polyurea polymer (I) and 1% to 30% by weight of a hydrophilically modified polyisocyanate (II) having silane and thioallophanate structures as a crosslinker component.

14. A method for producing multilayer composites comprising providing the two-component polyurethane dispersion adhesives as claimed in claim 1, on a substrate.

15. Multilayer composites produced or obtained by using the two-component polyurethane dispersion adhesives as claimed in claim 1.

16. The method as claimed in claim 14, wherein the substrate comprises a synthetic substrate and/or a substrate with a metallic surface.
